(19) United States
(12) Patent Application Publication
(10) Pub. No.: US 2014/0199668 A1
(43) Pub. Date: Jul. 17, 2014

(54) MULTIPLICATION TABLE TRAINING TOOL AND METHOD

(71) Applicant: Michael L. Callaghan, Shelton, WA (US)

(72) Inventor: Michael L. Callaghan, Shelton, WA (US)

(21) Appl. No.: 14/155,290

(22) Filed: Jan. 14, 2014

Related U.S. Application Data
(60) Provisional application No. 61/752,109, filed on Jan. 14, 2013.

(51) Int. Cl. G09B 19/02

(52) U.S. Cl. CPC G09B 19/02
USPC 434/209

(57) ABSTRACT

A visual tool and method used to learn the multiplication tables of two single digit numbers, 1-9. The tool is a graphic grid divided into eighty-one equal size squares by nine vertical columns and nine vertical rows. The grid lines around each set of three columns and three rows are highlighted and form nine subset boxes each containing 9 squares. The entire grid or individual rows, columns or subset boxes are associated with at least one multiple from the set of integers 1-9. The squares in each row, column and each subset box are randomly associated with a known or unknown numeral value equal to the product of the multiple associated with the row, column or subset box and a published or unpublished multiplicand. Some of the squares in the rows, columns and subset boxes contain randomly distributed unique product clues and most are empty. In some levels, the multiplicands are determined from the product clues. By examining the product clue, its location in the row, column or subset box, identifying a multiplicand with a suitable range value that has not been previously used in the row, column, and subset box, the products are determined and imputed into the empty squares.

This utility patent application is based on and claims the filing date benefit of U.S. utility patent application (Application No. 61/752,109) filed on Jan. 14, 2013.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention The present invention relates to teaching aids and methods that use visual learning and memory aids, and more particular to such aids for learning and memorizing multiplication tables.

2. Description of the Related Art

Puzzles requiring placing numbers in a square grid (usually nine-by-nine squares) based on clues or placement rules are common in the prior art. Sudoku is a puzzle that uses a large grid divided into nine groups each divided by a three by three grid so each group contains nine boxes. Printed in one of more boxes in each group are numbers that act as clues used to fill the other boxes in the group. The goal of Sudoku is to fill all of the boxes in the entire grid so the numbers 1 through 9 appear just once in every row, column, and in the three-by-three box.

Kakuro is another puzzle game that uses a grid similar to a crossword puzzle except numbers are used in place of letters. The numbers in a row or column when added together, act as clues to determine the number missing in an empty box.

Multiplication tables are commonly used by elementary teachers to teach multiplication and division. The tables typically use two multiples of 1-9. The result or answer of a multiplication problem is known as the ‘product’ and both the multiples and product must be memorized by the student. Gradually with practice, students can recall the products when two multiples are used and understand their relationships with all integers.

Young child become easily bored when learning multiplication tables. One tacit commonly used in a practice session is to force the child to determine a missing or unknown multiple (called a multiplicand) in some problems and determine the product in other problems. More particularly, the child may be presented simple problems requiring them to determine a multiplicand when multiplied by a known number (called a multiple) to produce a known product. During the same session, other problems may be presented in which the previously unknown multiplicand is now known and the previously known number or multiple is now unknown. In still other problems, the two multiples are presented and the child must determine the product. Maximum learning occurs when the three types of problems are used.

### SUMMARY OF THE INVENTION

Disclosed is a math multiplication teaching tool and method that helps a student to understand and memorize the multiplication tables by presenting the products of a known multiple and a multiplicand and then forcing the student to contemplate different multiplicands used to produce different products. Using the teaching tool, all three types of problem solving skills are being use and therefore learning is maximized. The tool also requires the student to hold in memory the entire of set of products and multiplicands that may be used with a particular multiple.

More specifically, the tool is a physical object such as a piece of paper, or a virtual image on a display. The tool includes a planar graphic grid divided into 81 equal size squares by nine vertical columns and nine vertical rows. The grid lines around each set of three columns and three rows are highlighted and form nine subset boxes each containing nine squares. The entire grid or individual rows, columns or subset boxes are associated with at least one multiple from the set of integers 1-9. The squares in each row, column and each subset box are randomly associated with a known or unknown numeral value equal to the product of the multiple associated with the row, column or subset box and a multiplicand. By reviewing known product clues in a few squares located in the same column, row or subset box, the range value of the multiplicands can be determined. In most instances, the range value is the common multiple of all of the products shown on the grid, column, row, or subset box.

Some of the squares in the rows, columns and subset boxes contain randomly distributed unique product clues. The remaining squares in the row, column and subset boxes are empty and filled in by the student. During use, the missing products are determined by examining the product clues in the column, row, or subset square, its location in the row, column or subset box, identifying the range value of the multiplicand, determining if the multiplicands has not be previously used in the row, column, and subset box, selecting the multiplicand, and then writing the product of the multiple and the multiplicand in the empty square.

In a first level, the entire grid is associated with one set of multiple integers 1-9. The squares in each row, column and each subset box are assigned a numeral value equal to the product of the one of the integers times a multiplicand. Because the entire grid is associated with one set of multiple integers 1-9, determination of the multiplicand and the product are relatively easy to master for beginning students.

In a second level of the game, which is more difficult, one or a group of columns, rows, or subset boxes are randomly assigned to the same or different multiplicands. Product clues are then provided in the squares in the columns, rows and subset boxes that enable the user to determine the multiplicands and the products to be imputed into the empty squares.

In a third level of the game, the nine subset boxes are randomly assigned a unique multiple and the squares in each subset box contain product clues or are empty. The product clues are products of one of the integers in the set of multiples and a multiplicand assigned to the subset box. The product clues are then provided in the columns, rows and subset boxes that are relevant only to the subset box where it is located. For each subset box, the range value of the multiplicands must be determined before the products to be imputed into the empty squares.

In levels 1 and 2, where the same multiplicands are associated with the squares in all the columns, rows, or subset boxes, the product or product code can be used only once in the column, row or subset box. In level 3, the multiplicands associated with the subset boxes may be different and the same product and products clues may be found in the same row or column.

The goal of the tool is to help the student memorize the multiplication table for the integers 1-9 by randomly presenting some of the products on columns, identifying the range values of the multiplicands, and calculate the missing products to be imputed into the empty squares in the column, row or subset box. During play, the numerical values of the products are presented in some of the squares. The student is then forced to ‘reverse engineer’ and determine the multiplicand(s). When all of the squares are completed correctly, the grid is completed.

### BRIEF DESCRIPTION OF THE DRAWINGS

FIG. 1 is an illustration of a partially completed grid to be played in accordance with the rules to be played at level 1.

FIG. 2 is an illustration of a completed grid to be played in accordance with the rules to be played at level 1.

FIG. 3 is an illustration of a partially completed grid to be played in accordance with the rules to be played at level 2.

FIG. 4 is a. 1 is an illustration of a completed grid to be played in accordance with the rules to be played at level 2.

FIG. 5 is an illustration of a partially completed grid to be played in accordance with the rules to be played at level 3.

FIG. 6 is a. 1 is an illustration of a completed grid to be played in accordance with the rules to be played at level 3.

### DESCRIPTION OF THE PREFERRED EMBODIMENT(S)

Disclosed herein is a math multiplication teaching tool 8 and method that requires students 90 to learn multiplication tables using a grid 10 that presents the products 50, 50′ of the known integer from a set of nine multiples 40 and a multiplicand 60. By using a grid 10 divided into columns 22, rows 26 and subsets boxes 30, students 90 can quickly learn the multiplication table of the integers and different multiplicands 60 by completing numbers based on determining the produce of an unknown multiplicand multiplied by the multiple.

The grid 10 includes a plurality of squares 20 aligned in vertical columns 22 and horizontal rows 26. Presented in some squares 20 are product clues 50 which is the product created when one of the integers of a set of multiples 40 and a multiplicand 60 are multiplied together. In the first embodiment, the student 90 must determine the range value of the multiplicand based on the products 50 originally shown in the squares 20 located in the columns 22, the rows 24 and subset boxes 30. The range value may be the common multiples of all of the products clues 50. The student 90 then determines the produced code 50′ and inputs it into an empty square 20.

The grid 10 includes an outer perimeter box 12 divided into eighty-one squares 20 created by an eight vertical grid lines 14 and eight horizontal lines 16. The lines 14, 16 around each set of three adjacent columns 22 and three stacked rows 26 are associated and form nine subset boxes 30 each containing nine squares 20. The entire grid 10 or individual columns 22, rows 26 or subset boxes 30 are associated with at least one integer from the set of 1-9 multiples 40. The set 40 may be printed on the top or side the grid 10. The squares 20 in each column 22, each row 26, and each subset box 30 are randomly associated with a product number 50 calculated by multiplying a multiple in the set of 1-9 multiples 40 and a multiplicand 60. The multiplicand 60 may be printed on the grid 8 for younger students or hidden thereby requiring it to be determined by the student 90. If the multiplicand 60 is not present, the range value may be the common denominator of the product clues 50.

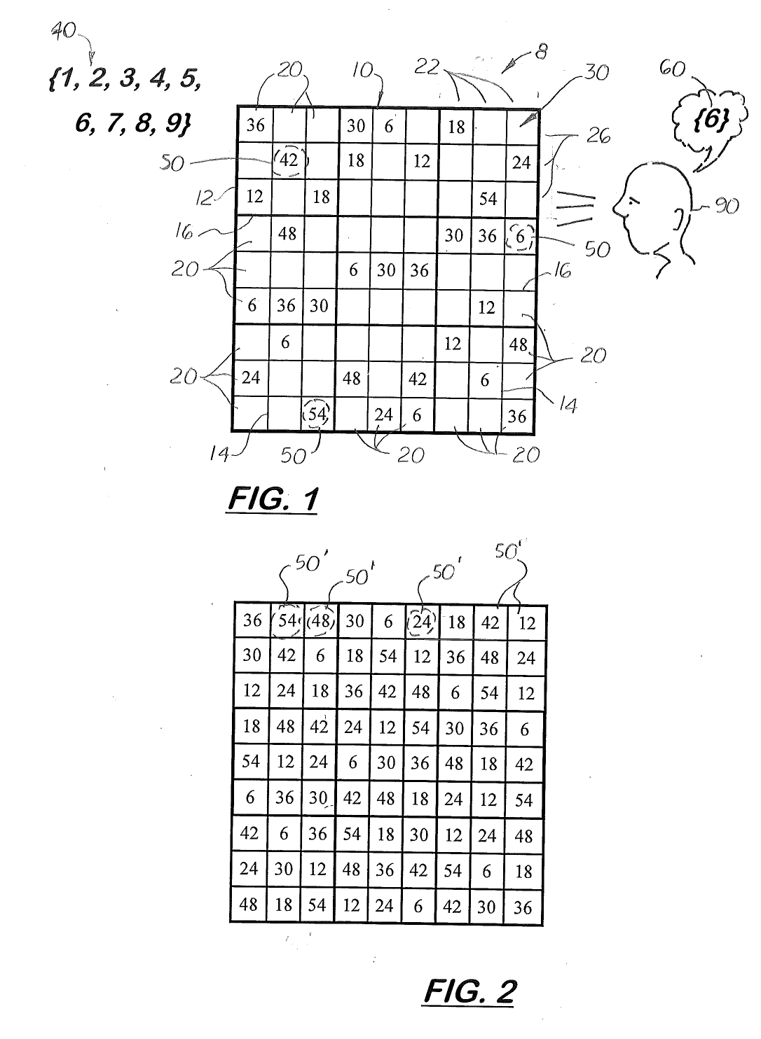

There are three levels of play. In level 1, shown in FIGS. 1 and 2, the entire grid 10 is assigned to one set of 1-9 multiples 40 and the products clues 50 are randomly presented in some of the squares 30. The remaining squares in a row, column and subset are empty. The numeral value and placement of the product clues 50 are configured in the columns 22, rows, 26 and the subset boxes 30 so that when completed, the product clues 50 and products 50′ associated with one multiplicand 60 and all of the set of 1-9 multiples 40 is presented on the grid 10. In levels 1 and 2, the multiplicand 60 may be presented to the student 90 or it may be unpublished and must be determined by the student 90 from the product codes 50 presented on the grid 10. The rules may limit that the numerical value of the product code 50 and product 50′ can only be used once in a column 22, row 26 or subset box 30.

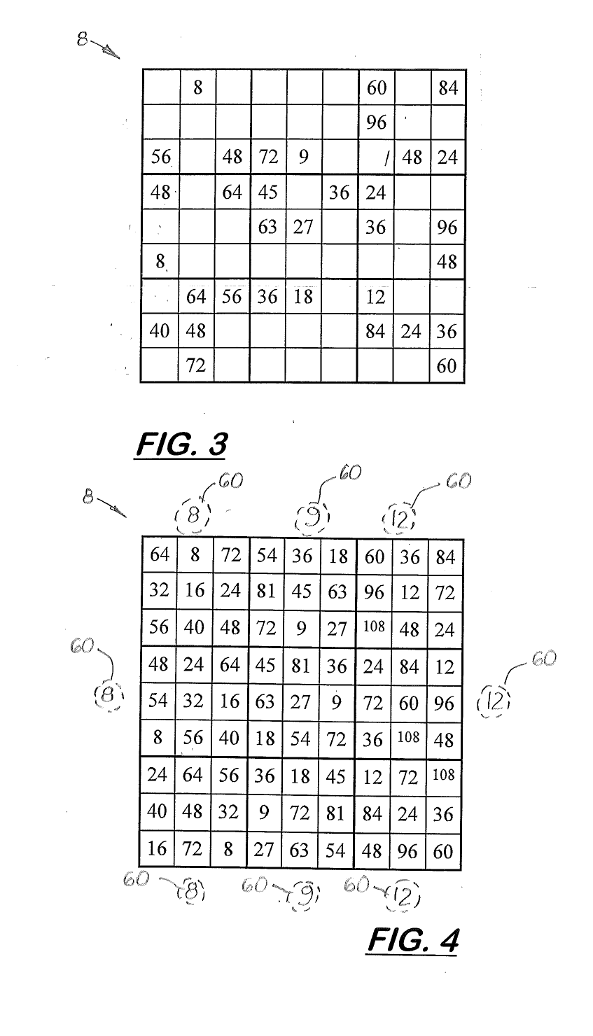

In level 2, the tool 8 is more challenging because it requires the student to consider the product clues 50 derived by using sets of 1-9 multiples 40 and different multiplicands 60 assigned to different vertically aligned subset squares 30. FIGS. 3 and 4 are illustrations of partially completed and completed grids 10, respectively, played under the rules to be played at level 2.

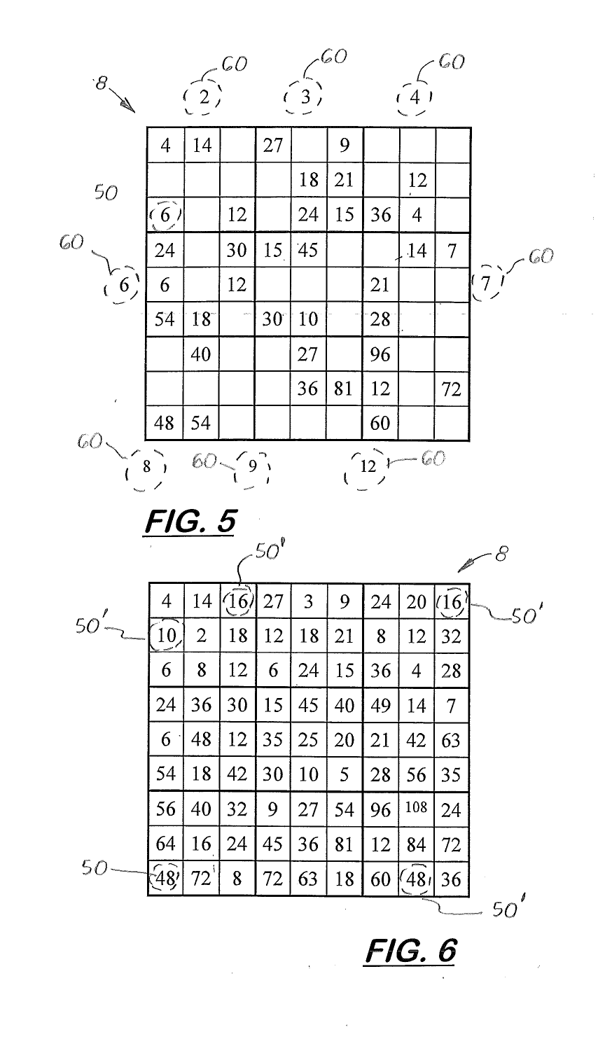

In level 3, the tool 8 is even more challenging because it requires the student 90 to separately consider the product clues 50 in each subset box 30. Also each subset box 30 may be associated with different multiplicands 60. FIGS. 5 and 6 are illustrations of partially completed and completed grids 10, 10′, respectively, played under the rules to be played at level 3. In the level 3 of the game, the numerical value of same product code 50 and product 50′ can be presented in squares in the same column 22, row 26.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A tool for learning the multiplication table of two numbers, comprising:
a. a grid associated with the multiple, said grid divided into eighty-one squares created by a 9×9 horizontal and vertical grid lines, and forming nine vertical columns and nine vertical rows, the box also being divided into 9 subset boxes each containing 9 squares, each square in said row, column, or subset box being associated with the product of one of a multiplicands when multiplied by a known integer in the set of multiples 1-9; and, b. a set of multiples integers 1-9, said multiple integers being associated with all 81 squares in said grid, or with said squares located in one or more said vertical columns, or one or more said horizontal rows, or with said squares in at least one said subset box.

2. The tool, as recited in claim 1, wherein said multiplicand associated with each said product is an integer from a set of integers 1-9.

3. The tool, as recited in claim 1, wherein said product are randomly distributed in said rows, said columns and said subset box.

4. A method for teaching multiplication tables of two numbers;
a. selecting a box divided by 9×9 horizontal and vertical lines into 81 squares, each three horizontal and vertical lines being used to create nine subset boxes each containing nine squares, each square in a row, column, or subset box being associated with a single unique product of a known multiple associated with said subset box and a multiplicand between the integers 1-9, some squares in said row, said columns and said subset boxes containing unique products produced of said multiple and a particular multiplicand to be determined by a user and some squares are empty; and
b. inputting the products in all of the empty squares in each said row, each said column, and each said subset box,

5. A tool for learning the multiplication table of two numbers, comprising:
a. a box divided into 81 squares created by a 9×9 horizontal and vertical grid lines, and forming 9 vertical columns and 9 vertical rows, the box also being divided into 9 square subset box each containing 9 squares, each square in a row or column or in a subset being associated with a multiple of a number between 1-9, said box being associated with a known multiple;
b. a product of said known multiple and an unknown multiplicand presented some of said squares in the row, column or subset box, the products being derived by multiplying said multiple comprising numbers 1-9 and 12 with a multiplicand comprising the numbers 1-9; and,
c. a plurality of empty squares located in each row, each column, and in each subset, the empty squares being associated with an unpublished product that is derived by multiplying said multiple with said multiplicand not been previously used to derive the product in another square in the same row, column, or subset.
